(19) United States
(12) Patent Application Publication
(10) Pub. No.: US 2026/0309975 A1
(43) Pub. Date: Oct. 8, 2026

(54) DEVICE FOR APPLYING VOLTAGE TO LIQUID

(71) Applicant: SHARP KABUSHIKI KAISHA, Sakai City (JP)

(72) Inventors: TAKESHI HARA, Sakai City (JP); HIROAKI FURUKAWA, Sakai City (JP); Eiji FUJIMOTO, Sakai City (JP); MASAKI FUJIWARA, Sakai City (JP); TETSUO FUJITA, Sakai City (JP); AKIHIRO ODA, Sakai City (JP)

(21) Appl. No.: 19/633,719

(22) Filed: Mar. 30, 2026

(30) Foreign Application Priority Data
Apr. 3, 2025 (JP) 2025-062069

(51) Int. Cl. G02B 26/00

(52) U.S. Cl. CPC G02B 26/005

(57) ABSTRACT

A first substrate includes a support body, a plurality of first electrodes, a first wiring line located between the support body and the first electrode, a first organic insulating film located between the first wiring line and the first electrode, a second organic insulating film located between the first organic insulating film and the first electrode, and a metal layer located between the first organic insulating film and the second organic insulating film and formed of a metal that is not eroded by a liquid.

### CROSS-REFERENCE TO RELATED APPLICATIONS

This application claims the benefit of priority to Japanese Patent Application Number 2025-062069 filed on Apr. 3, 2025. The entire contents of the above-identified application are hereby incorporated by reference.

### BACKGROUND

### Technical Field

The disclosure relates to a device for applying a voltage to a liquid.

Various devices using electrowetting have been developed. JP 2016-535866 T (published on Nov. 17, 2016) discloses an electrowetting display.

### SUMMARY

However, not only in the electrowetting device, but also in a device for applying a voltage to a liquid, such as a device for measuring a potential of a liquid, a device for performing electrophoresis, and a device for using an electrical reaction of a liquid, the liquid may enter a wiring line in the device. Although a protection layer for reducing the entering of the liquid is provided, a crack may occur in the protection layer, and the wiring line below the protection layer may be eroded by the liquid. Such erosion reduces durability and reliability of the device.

An object of an aspect of the disclosure is to improve the durability and reliability of the device for applying a voltage to a liquid.

In order to solve the above problem, a device for applying a voltage to a liquid according to one aspect of the disclosure is a device for applying a voltage to a liquid, and the device is configured to include a first substrate including a support body, a plurality of first electrodes, a first wiring line located between the support body and the plurality of first electrodes, a first organic insulating film located between the first wiring line and the plurality of first electrodes, a second organic insulating film located between the first organic insulating film and the plurality of first electrodes, and a metal layer located between the first organic insulating film and the second organic insulating film and formed of a metal that is not eroded by the liquid, a second substrate including a second electrode facing the plurality of first electrodes, wherein a gap into which the liquid is injected or is injectable is maintained between the first substrate and the second substrate.

According to an aspect of the disclosure, the durability and reliability of the device for applying a voltage to a liquid can be improved.

### BRIEF DESCRIPTION OF DRAWINGS

The disclosure will be described with reference to the accompanying drawings, wherein like numbers reference like elements.

FIG. 1 is a partial cross-sectional view illustrating a configuration example of an electrowetting device according to an embodiment of the disclosure.

FIG. 2 is a partial plan view illustrating a configuration example of a first wiring line in the electrowetting device illustrated in FIG. 1.

FIG. 3 is a partial plan view illustrating another configuration example of the first wiring line in the electrowetting device illustrated in FIG. 1.

FIG. 4 is a partial plan view illustrating still another configuration example of the first wiring line in the electrowetting device illustrated in FIG. 1, together with a part of a second wiring line.

FIG. 5 is a partial cross-sectional view illustrating a cross section taken along a line AA in FIG. 4.

FIG. 6 is a partial plan view illustrating still another configuration example of the first wiring line in the electrowetting device illustrated in FIG. 1, together with a part of a second wiring line.

FIG. 7 is a partial cross-sectional view illustrating a cross section taken along a line AA in FIGS. 6 and 8.

FIG. 8 is a partial cross-sectional view illustrating a cross section taken along a line BB in FIGS. 6 and 7.

FIG. 9 is a flowchart illustrating an example of a manufacturing method for the electrowetting device illustrated in FIG. 1.

FIG. 10 is a partial cross-sectional view illustrating a configuration example of an electrowetting device according to an embodiment of the disclosure.

FIG. 11 is a partial plan view illustrating a configuration example of a first wiring line in the electrowetting device illustrated in FIG. 10, together with a part of a second wiring line.

FIG. 12 is a partial cross-sectional view illustrating a cross section taken along a line AA in FIG. 11.

FIG. 13 is a partial plan view illustrating another configuration example of the first wiring line in the electrowetting device illustrated in FIG. 10, together with a part of the second wiring line.

FIG. 14 is a partial cross-sectional view illustrating a cross section taken along a line AA in FIG. 13.

FIG. 15 is a partial cross-sectional view illustrating a configuration example of an electrowetting device according to an embodiment of the disclosure.

FIG. 16 is a partial plan view illustrating a configuration example of a first wiring line in the electrowetting device illustrated in FIG. 15, together with a part of a second wiring line.

FIG. 17 is a partial cross-sectional view illustrating a cross section taken along a line AA in FIG. 16.

FIG. 18 is a partial plan view illustrating another configuration example of the first wiring line in the electrowetting device illustrated in FIG. 15, together with a part of the second wiring line.

FIG. 19 is a partial cross-sectional view illustrating a cross section taken along a line AA in FIG. 18.

FIG. 20 is a partial cross-sectional view illustrating a configuration example of an electrowetting device according to an embodiment of the disclosure.

FIG. 21 is a partial plan view illustrating a configuration example of a first wiring line in the electrowetting device illustrated in FIG. 20, together with a part of a second wiring line.

FIG. 22 is a partial cross-sectional view illustrating a cross section taken along a line AA in FIG. 21.

FIG. 23 is a partial plan view illustrating another configuration example of the first wiring line in the electrowetting device illustrated in FIG. 20, together with a part of the second wiring line.

FIG. 24 is a partial cross-sectional view illustrating a cross section taken along a line AA in FIG. 23.

FIG. 25 is a partial cross-sectional view illustrating a configuration example of an electrowetting device according to an embodiment of the disclosure.

### DESCRIPTION OF EMBODIMENTS

Hereinafter, for the sake of simplicity of description, an electrowetting device using electrowetting will be illustrated as an example. However, the scope of the disclosure is not limited to the electrowetting device, and encompasses a device for applying a voltage to a liquid, such as a device for measuring a potential of a liquid, a device for performing electrophoresis, and a device for using an electrical reaction of a liquid.

### First Embodiment

An embodiment of the disclosure will be described below.

### Configuration of Electrowetting Device

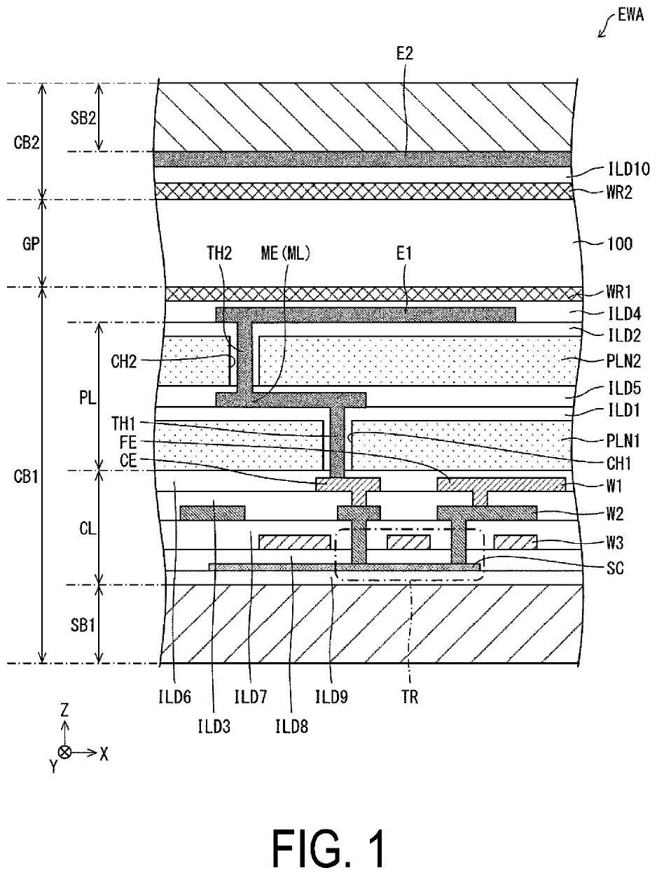

FIG. 1 is a partial cross-sectional view illustrating a configuration example of an electrowetting device EWA according to an embodiment of the disclosure. As illustrated in FIG. 1, the electrowetting device EWA according to the disclosure is a device for applying a voltage to a liquid 100, including a first substrate CB1 and a second substrate CB2, and maintaining a gap GP into which the liquid 100 is injected or can be injected between the first substrate CB1 and the second substrate CB2. The first substrate CB1 includes a support body SB1, a plurality of first electrodes E1, a first wiring line W1 located between the support body SB1 and the plurality of first electrodes E1, a first organic insulating film PLN1 located between the first wiring line W1 and the plurality of first electrodes E1, a second organic insulating film PLN2 located between the first organic insulating film PLN1 and the plurality of first electrodes E1, and a metal layer ML located between the first organic insulating film PLN1 and the second organic insulating film PLN2 and formed of a metal that is not eroded by the liquid 100. The second substrate CB2 includes a second electrode E2 facing the plurality of first electrodes E1.

The electrowetting device EWA selects one or more first electrodes E1 from the plurality of first electrodes E1 and applies a voltage between the selected first electrodes E1 and the second electrode E2. As a result, a voltage is applied to a portion of the liquid 100 corresponding to the selected first electrodes E1.

According to the above configuration, the electrowetting device EWA according to the disclosure includes, between the first wiring line W1 and the plurality of first electrodes E1, a protection layer PL including the first organic insulating film PLN1, the second organic insulating film PLN2, and the metal layer ML located between the first organic insulating film PLN1 and the second organic insulating film PLN2 and formed of a metal that is not eroded by the liquid 100. As compared with the known electrowetting device in which the protection layer is only one organic insulating layer, the protection layer PL according to the disclosure is less likely to be penetrated by a crack in the thickness direction for the following two reasons. One of the reasons is that the total thickness of the protection layer PL according to the disclosure is large due to the plurality of organic insulating films PLN1 and PLN2. The other reason is that even when a crack occurs in any of the plurality of organic insulating films PLN1 and PLN2, the crack is likely to stop between the plurality of organic insulating films PLN1 and PLN2.

According to the above configuration according to the disclosure, since the metal layer ML is provided in the protection layer PL, even when the total thickness of the protection layer PL is large, it is easy to electrically connect the first electrode E1 to the first wiring line W1. This is because a connection from the first electrode E1 to the first wiring line W1 can be separately implemented by a connection from the first electrode E1 to the metal layer ML and a connection from the metal layer ML to the first wiring line W1.

The “above”, “upper side”, “upward direction”, and the like in the disclosure mean a side on which the second substrate CB2 is located with respect to the first substrate CB1, and this direction is defined as a Z-axis positive direction. The “lower”, “lower side”, “downward direction”, and the like mean a side on which the first substrate CB1 is located with respect to the second substrate CB2, and this direction is defined as a Z-axis negative direction. The “lateral”, “lateral direction”, and the like mean a direction orthogonal to the Z-axis, and one of the directions orthogonal to the Z-axis is defined as an X-axis direction, and a direction orthogonal to both the Z-axis and the X-axis is defined as a Y-axis direction.

In the disclosure, “cross-sectional view” means viewing from a direction orthogonal to the Z-axis, and “plan view” means viewing from the Z-axis direction. In the disclosure, “thickness”, “height”, “depth”, and the like mean the size in the Z-axis direction.

The first substrate CB1 may further include a first inorganic insulating film ILD1 located between the first wiring line W1 and the plurality of first electrodes. The inorganic film is denser than the organic film, and can further reduce the entering of the liquid 100. Thus, the first inorganic insulating film ILD1 can further reduce the entering of the liquid 100 to the first wiring line W1.

The first inorganic insulating film ILD1 may be located between the first organic insulating film PLN1 and the second organic insulating film PLN2. The first inorganic insulating film ILD1 can reduce the entering of the liquid 100 to the first organic insulating film PLN1, reduce the swelling of the first organic insulating film PLN1, and reduce the occurrence of a crack in the first organic insulating film PLN1. Thus, the liquid 100 is further less likely to reach the first wiring line W1.

The first substrate CB1 may further include a second inorganic insulating film ILD2 located between the second organic insulating film PLN2 and the plurality of first electrodes E1. The second inorganic insulating film ILD2 can reduce the entering of the liquid 100 to the second organic insulating film PLN2, reduce the swelling of the second organic insulating film PLN2, and reduce the occurrence of a crack in the second organic insulating film PLN2. Thus, the liquid 100 is further less likely to reach the first wiring line W1.

The first substrate CB1 further includes a first through-conductor TH1 penetrating the first organic insulating film PLN1 and a second through-conductor TH2 penetrating the second organic insulating film, one of the plurality of first electrodes E1 is connected to the metal layer ML through the second through-conductor TH2, and the metal layer ML is connected to the first wiring line W1 through the first through-conductor TH1. Thus, one of the plurality of first electrodes E1 can be electrically connected to the first wiring line W1 through the second through-conductor TH2, the metal layer ML, and the first through-conductor TH1. The second through-conductor TH2 is preferably separated from the first through-conductor TH1 in a plan view. Since the second through-conductor TH2 is separated from the first through-conductor TH1, even when the liquid 100 reaches the metal layer ML along the second through-conductor TH2, the liquid 100 is less likely to reach the first through-conductor TH1. Thus, the liquid 100 is less likely to reach the first wiring line W1.

The first substrate CB1 may include a plurality of the first through-conductors TH1 and a plurality of the second through-conductors TH2 so as to correspond to the plurality of first electrodes E1. In this case, the metal layer ML includes a plurality of intermediate electrodes ME corresponding to the plurality of first electrodes E1, and the first wiring line W1 includes a plurality of connection electrodes CE corresponding to the plurality of first electrodes E1. Each of the plurality of first electrodes E1 is connected to the corresponding connection electrode CE via the corresponding second through-conductor TH2, the corresponding intermediate electrode ME, and the corresponding first through-conductor TH1.

The first wiring line W1 may be a wiring line containing a metal that is eroded by the liquid 100. The first wiring line W1 among wiring lines containing a metal that is eroded by the liquid 100 in the first substrate CB1 may be a wiring line closest (located at the uppermost position in FIG. 1) to the plurality of first electrodes E1. The first substrate CB1 includes one or more wiring lines, for example, a second wiring line W2 and a third wiring line W3, located between the support body SB1 and the first wiring line W1. One or both of the second wiring line W2 and the third wiring line W3 may be a wiring line containing a metal that is eroded by the liquid 100. Since the liquid 100 is less likely to reach the first wiring line W1, the liquid 100 is also less likely to reach the remaining wiring lines that are farther from the first electrode E1 than the first wiring line W1.

The first substrate CB1 is located between the support body SB1 and the first wiring line W1, and further includes a plurality of circuit elements TR corresponding to the plurality of first electrodes E1, respectively. The first substrate CB1 may include a circuit layer CL located between the support body SB1 and the protection layer PL. The circuit layer CL may include one or more wiring lines W1, W2, and W3, and may include one or more semiconductor layers SC. The semiconductor layer SC may contain an oxide semiconductor such as low temperature poly-silicon (LTPS), amorphous silicon, and indium gallium tin oxide (InGaZnO). The semiconductor layer SC may contain a p-type semiconductor or an n-type semiconductor. The circuit layer CL may include both the p-type semiconductor layer and the n-type semiconductor layer. The circuit element TR may be a transistor having a channel made of the semiconductor layer SC.

The first substrate CB1 may include a third inorganic insulating film ILD3 located between the first wiring line W1 and the second wiring line W2.

The first substrate CB1 may include a liquid repellent layer WR1 located on the opposite side of the support body SB1 with respect to the plurality of first electrodes E1 and repelling the liquid 100, and a fourth inorganic insulating film ILD4 located between the plurality of first electrodes E1 and the liquid repellent layer WR1. The liquid repellent layer WR1 and the fourth inorganic insulating film ILD4 can cover the plurality of first electrodes E1 to reduce the contact of the liquid 100 with any one or more of the plurality of first electrodes E1. The liquid repellent layer WR1 and the fourth inorganic insulating film ILD4 can cover the second organic insulating film PLN2 to reduce permeation of the liquid 100 into the second organic insulating film PLN2. The liquid repellent layer WR1 and the fourth inorganic insulating film ILD4 can reduce the entering of the liquid 100 into the support body SB1 side (the lower side in FIG. 1) from the second organic insulating film PLN2 along the lower face of the first electrodes E1 and the side surface of the second through-conductor TH2. Thus, the durability and reliability of the electrowetting device EWA can be further improved.

The liquid repellent layer WR1 and the fourth inorganic insulating film ILD4 may be a dielectric. The electrowetting device EWA may be an electrowetting on dielectric (EWOD) device in which the plurality of first electrodes E1 are covered with a dielectric.

The first substrate CB1 may include a fifth inorganic insulating film ILD5 located between the metal layer ML and the second organic insulating film PLN2, and the first inorganic insulating film ILD1 may be located between the first organic insulating film PLN1 and the metal layer ML. The circuit layer CL of the first substrate CB1 may include a plurality of inorganic insulating films such as the third inorganic insulating film ILD3 located between the first wiring line W1 and the second wiring line W2, an inorganic insulating film ILD6 located between the first wiring line W1 and the first organic insulating film PLN1, an inorganic insulating film ILD7 located between the third wiring line W3 and the second wiring line W2, an inorganic insulating film ILD8 located between the semiconductor layer SC and the third wiring line W3, and an inorganic insulating film ILD9 located between the support body SB1 and the third wiring line W3.

The second substrate CB2 may include a support body SB2, a liquid repellent layer WR2 located on the opposite side of the support body SB2 with respect to the second electrode E2 and repelling the liquid 100, and an inorganic insulating film ILD10 located between the second electrode E2 and the liquid repellent layer WR2. The liquid repellent layer WR2 and the inorganic insulating film ILD10 can cover the second electrode E2 to reduce the contact of the liquid 100 with the second electrode E2.

### Configuration of Wiring Line

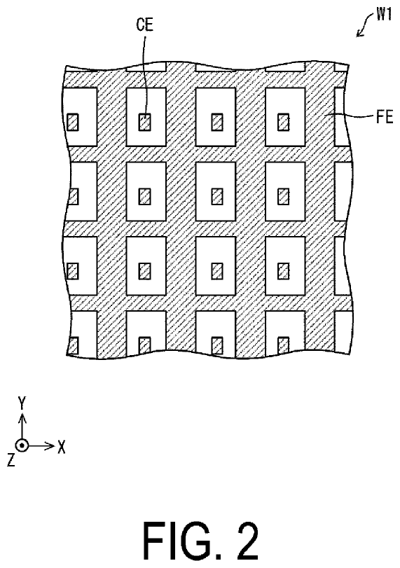

FIG. 2 is a partial plan view illustrating a configuration example of the first wiring line W1 in the electrowetting device EWA illustrated in FIG. 1. For the sake of facilitating understanding of FIG. 2, the first wiring line W1 in FIG. 2 is hatched in the same manner as in FIG. 1. As illustrated in FIGS. 1 and 2, the first wiring line W1 may include (i) the plurality of connection electrodes CE each connected to both corresponding one of the plurality of first electrodes E1 and corresponding one of the plurality of circuit elements TR, and (ii) one supply electrode FE not connected to any of the plurality of first electrodes E1 and connected to each of the plurality of circuit elements TR. The area of the supply electrode FE in a plan view is preferably small. For example, the area of the supply electrode FE in a plan view is preferably 80% or less, more preferably 50% or less, and further preferably 30% or less of the area of the first substrate CB1 in a plan view. Since the area of the supply electrode FE is small, even when a crack penetrates the protection layer PL in the thickness direction, the probability that the supply electrode FE is present ahead of the crack is small. Thus, the probability that the liquid 100 erodes the supply electrode FE through the crack is small.

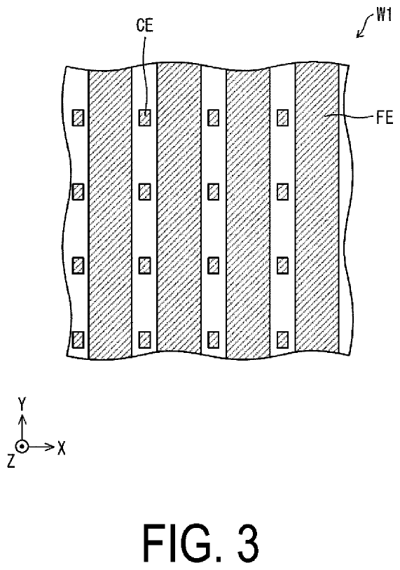

FIG. 3 is a partial plan view illustrating another configuration example of the first wiring line W1 in the electrowetting device EWA illustrated in FIG. 1. For the sake of facilitating understanding of FIG. 3, the first wiring line W1 in FIG. 3 is hatched in the same manner as in FIG. 1. As illustrated in FIGS. 1 and 3, the first wiring line W1 may include (i) the plurality of connection electrodes CE each connected to both corresponding one of the plurality of first electrodes E1 and corresponding one of the plurality of circuit elements TR, and (ii) a plurality of the supply electrodes FE each not connected to any of the plurality of first electrodes E1 and connected to corresponding one or more of the plurality of circuit elements TR.

According to the configuration illustrated in FIG. 3, the plurality of supply electrodes FE are separated from each other and the plurality of connection electrodes CE in a plan view. Since the supply electrodes FE are separated from each other and are also separated from the connection electrodes CE, even when the liquid 100 reaches one of the plurality of supply electrodes FE, the liquid 100 is less likely to reach the other supply electrodes FE and the connection electrodes CE. Thus, the circuit elements TR in which the corresponding supply electrodes FE are damaged by one crack can be limited to some of the plurality of circuit elements TR. Thus, a design in which the electrowetting device EWA functions even when some of the circuit elements TR are damaged, that is, a so-called “design with high redundancy” is advantageous. Hereinafter, for the sake of simplicity of description, the “circuit elements TR in which the corresponding supply electrodes FE are damaged” is abbreviated as a “damaged circuit element TR”.

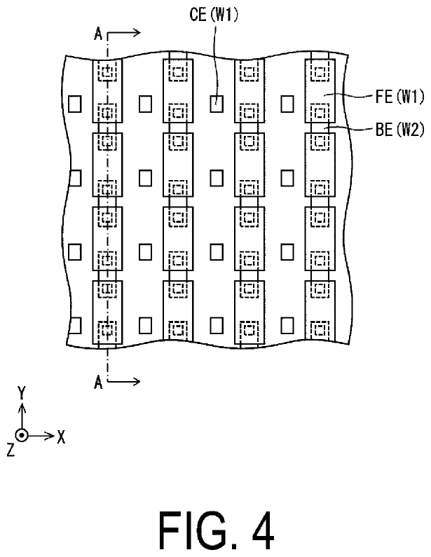

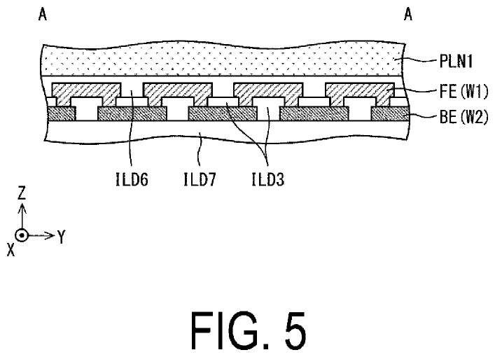

FIG. 4 is a partial plan view illustrating still another configuration example of the first wiring line W1 in the electrowetting device EWA illustrated in FIG. 1, together with a part of a second wiring line W2. FIG. 5 is a partial cross-sectional view illustrating a cross section taken along a line AA in FIG. 4. For the sake of simplicity of the drawings, the second wiring line W2 in FIGS. 4 and 5 illustrates only relay electrodes BE, each connected to two or more supply electrodes FE. As illustrated in FIGS. 1, 4, and 5, when the first substrate CB1 further includes the second wiring line W2 located between the plurality of circuit elements TR and the first organic insulating film PLN1, and the first wiring line W1 includes (i) the plurality of connection electrodes CE each connected to both corresponding one of the plurality of first electrodes E1 and corresponding one of the plurality of circuit elements TR, and (ii) a plurality of the supply electrodes FE each not connected to any of the plurality of first electrodes E1 and connected to corresponding one or more of the plurality of circuit elements TR, the second wiring line W2 may include a plurality of the relay electrodes BE, each connected to corresponding two or more of the plurality of supply electrodes FE.

As can be seen from the comparison in FIGS. 2 to 4, the supply electrode FE can be divided in both a row direction and a column direction (both an X direction and a Y direction) by the relay electrodes BE. Thus, the number of circuit elements TR damaged by one crack can be further reduced.

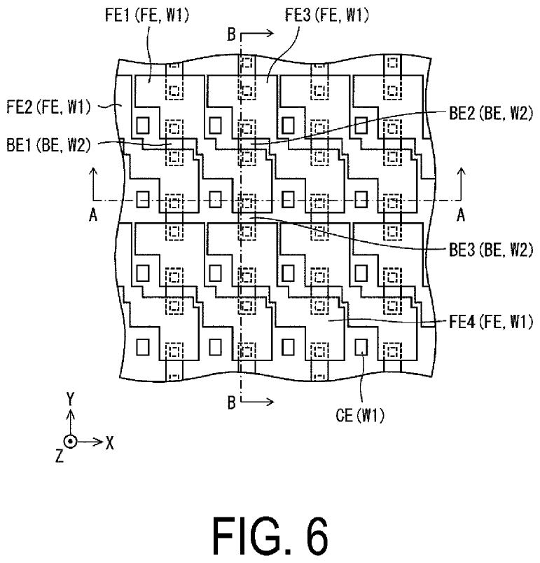

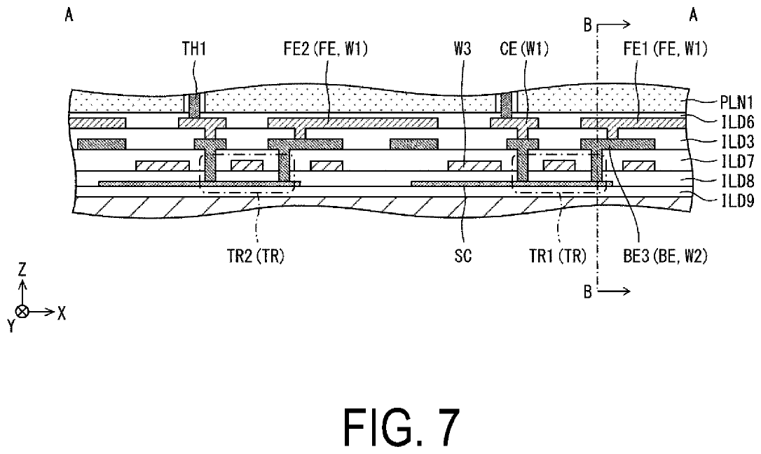

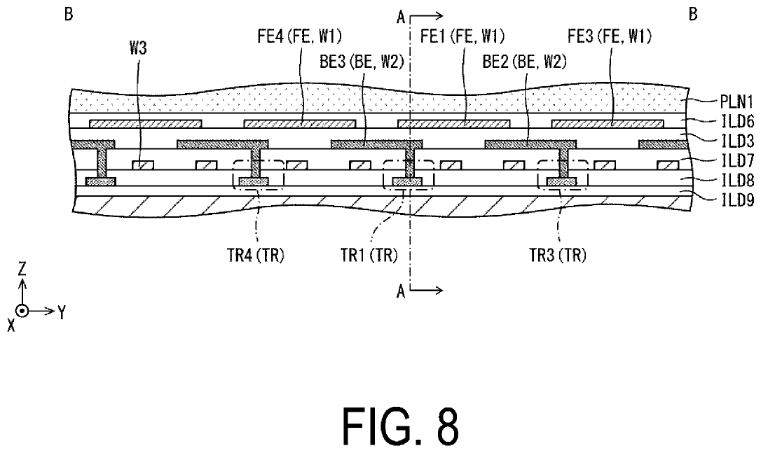

FIG. 6 is a partial plan view illustrating still another configuration example of the first wiring line W1 in the electrowetting device EWA illustrated in FIG. 1, together with a part of a second wiring line W2. FIG. 7 is a partial cross-sectional view illustrating a cross section taken along a line AA in FIGS. 6 and 8. FIG. 8 is a partial cross-sectional view illustrating a cross section taken along a line BB in FIGS. 6 and 7. For the sake of simplicity of the drawing, the second wiring line W2 in FIG. 6 illustrates only relay electrodes BE, each connected to two or more supply electrodes FE.

As illustrated in FIGS. 1 and 6 to 8, the plurality of circuit elements TR may include a first circuit element TR1, a second circuit element TR2 adjacent to the first circuit element TR1 on one side in the row direction (X direction), a third circuit element TR3 adjacent to the first circuit element TR1 on one side in the column direction (Y direction), and a fourth circuit element TR4 adjacent to the first circuit element TR1 on the other side in the column direction (Y direction). The plurality of supply electrodes FE may include a first supply electrode FE1 corresponding to the first circuit element TR1, a second supply electrode FE2 corresponding to the second circuit element TR2, a third supply electrode FE3 corresponding to the third circuit element TR3, and a fourth supply electrode FE4 corresponding to the fourth circuit element TR4. In this case, the plurality of relay electrodes BE may include a first relay electrode BE1 connected to the first and second supply electrodes FE1 and FE2, a second relay electrode BE2 connected to the first and third supply electrodes FE1 and FE3, and a third relay electrode BE3 connected to the first and fourth supply electrodes FE1 and FE4.

According to the configuration example illustrated in FIGS. 6 to 8, even when the liquid 100 erodes the third supply electrode FE3, power is supplied to the first supply electrode FE1 and the fourth supply electrode FE4 through the second supply electrode FE2. Thus, even when a crack occurs such that the liquid 100 reaches the third supply electrode FE3, the first circuit element TR1 and the fourth circuit element TR4 can operate. Similarly, even when a crack occurs such that the liquid 100 reaches the fourth supply electrode FE4, the first circuit element TR1 and the third circuit element TR3 can operate. Thus, the number of circuit elements TR damaged by one crack can be further reduced. In addition, the number of line defects in which the plurality of circuit elements TR arranged in the column direction, such as the first, third, and fourth circuit elements TR1, TR3, and TR4, are damaged can be reduced.

In addition to the metal layer ML, it is advantageous that the first electrode E1, the first through-conductor TH1, and the second through-conductor TH2 are also formed of metals that are not eroded by the liquid 100. The metal layer ML, the first electrode E1, the first through-conductor TH1, and the second through-conductor TH2 may be formed of the same metals or different metals.

Metal that is Regarded as Metal That is not Eroded by Liquid

The metal that is not eroded by the liquid 100 is a noble metal or a metal that reacts with the liquid 100 to form a passive layer. The metal that is eroded by the liquid 100 is a metal that does not react with the liquid 100 to form a passive layer. The “noble metal” in the disclosure includes gold (Au), silver (Ag), platinum (Pt), palladium (Pd), iridium (Ir), and rhodium (Rh). The “noble metal” in the disclosure further includes an alloy of two or more metals selected from the group consisting of gold, silver, platinum, palladium, iridium, and rhodium. When a noble metal element accounts for 10% or more, preferably 50% or more, and more preferably 80% or more in terms of molar ratio of a constituent element of a component, the constituent element is formed of the noble metal. A “base metal“ and a ”base metal element” in the disclosure are metals (elements) that are not noble metals (elements).

The liquid 100 is a liquid selected from the group consisting of ionic liquids, polar liquids such as water and alcohols, and electrolyte solutions. The ionic liquid is a melt of a salt having a melting point of 100° C. or less, preferably an ambient temperature molten salt. Thus, the liquid 100 is likely to erode the base metal. Some base metals such as titanium (Ti), niobium (Nb), tungsten (W), chromium (Cr), and nickel (Ni) form a passive layer with the liquid 100, and other base metals, such as aluminum (Al), molybdenum (Mo), and copper (Cu) do not form a passive layer with the liquid 100. When the metal layer ML is formed of a base metal that is passivated, and the liquid 100 comes into contact with the metal layer ML, a passive layer is formed on the surface of the metal layer ML and protects the interior of the metal layer ML. Thus, even when the liquid 100 enters the metal layer ML, the metal layer ML can contribute to the electrical conduction between the first electrode E1 and the first wiring line W1. The increase in the electrical resistance of the metal layer ML due to the formation of the passive layer is practically negligible, or the metal layer ML can be designed in anticipation of the increase in the electrical resistance.

It is advantageous that the metal that is not eroded by the liquid 100 is the base metal that reacts with the liquid 100 to form the passive layer. Since the noble metal cannot be wet-etched or dry-etched, it is difficult to process the noble metals into a desired shape. On the other hand, since the base metal can be etched, the metal layer ML can be easily patterned. The metal that is not eroded by the liquid 100 may be, for example, a metal selected from the group consisting of titanium, niobium, tungsten, chromium, and nickel, or an alloy of two or more metals selected from the group.

### Manufacturing Method

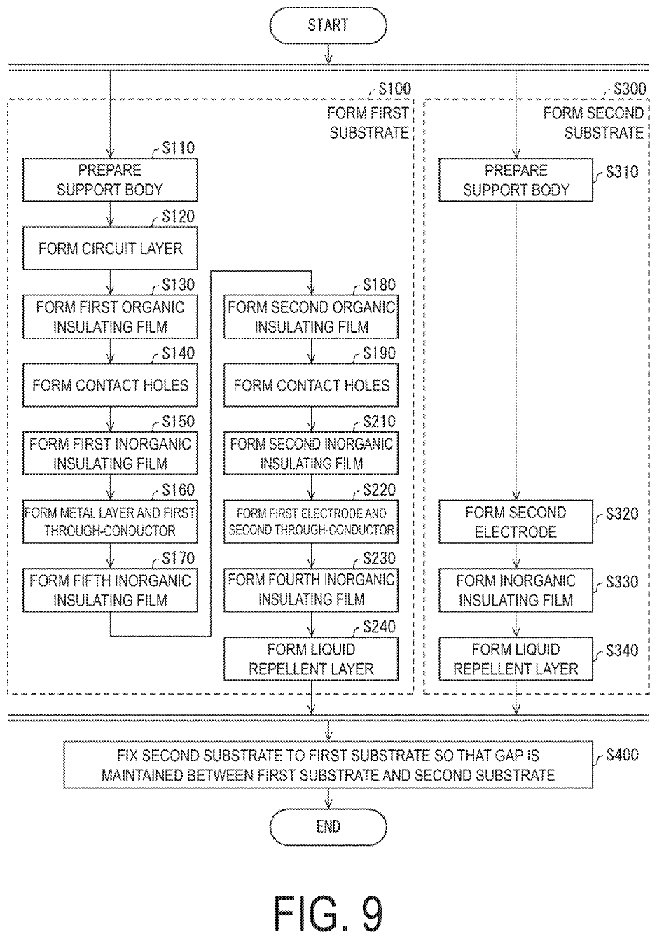

FIG. 9 is a flowchart illustrating an example of a manufacturing method for the electrowetting device EWA illustrated in FIG. 1. As illustrated in FIG. 9, the support body SB1 of the first substrate CB1 is prepared (step S110), and the circuit layer CL is formed on the support body SB1 (step S120).

The first organic insulating film PLN1 is formed on the circuit layer CL (step S130), and a contact hole CH1 extending through the first organic insulating film PLN1 is formed in the first organic insulating film PLN1 (step S140). The first organic insulating film PLN1 may be formed by applying a liquid containing an organic resin such as an acrylic resin and a polyimide resin onto the circuit layer CL and solidifying the liquid. The first organic insulating film PLN1 is preferably formed of a resin having a photosensitivity, that is, a photoresist so that the contact hole CH1 can be formed using photolithography.

Then, the first inorganic insulating film ILD1 is formed on the first organic insulating film PLN1 (step S150). The first inorganic insulating film ILD1 may be a single layer containing silicon oxide (SiOₓ), silicon nitride (SiNₓ), or silicon oxynitride (SiOₓN_{y}), or may be a multilayer in which silicon oxide and silicon nitride are alternately layered. The metal layer ML is formed on the first inorganic insulating film ILD1, and the first through-conductor TH1 is formed in each of the plurality of contact holes CH1 of the first organic insulating film PLN1 (step S160).

Then, the fifth inorganic insulating film ILD5 is formed on the metal layer ML (step S170). The fifth inorganic insulating film ILD5 may be a single layer containing silicon oxide (SiOₓ), silicon nitride (SiNₓ), or silicon oxynitride (SiOₓN_{y}), or may be a multilayer in which silicon oxide and silicon nitride are alternately layered. The second organic insulating film PLN2 is formed on the fifth inorganic insulating film ILD5 (step S180), and a contact hole CH2 extending through the second organic insulating film PLN2 is formed in the second organic insulating film PLN2 (step S190). The second organic insulating film PLN2 may be formed by applying a liquid containing an organic resin such as an acrylic resin and a polyimide resin onto the fifth inorganic insulating film ILD5 and solidifying the liquid. The second organic insulating film PLN2 is preferably formed of a photoresist so that the contact hole CH2 can be formed by photolithography.

Then, the second inorganic insulating film ILD2 is formed on the second organic insulating film PLN2 (step S210). The second inorganic insulating film ILD2 may be a single layer containing silicon oxide (SiOₓ), silicon nitride (SiNₓ), or silicon oxynitride (SiOₓN_{y}), or may be a multilayer in which silicon oxide and silicon nitride are alternately layered. The plurality of first electrodes E1 are formed on the second inorganic insulating film ILD2, and the second through-conductor TH2 is formed in each of the plurality of contact holes CH2 of the second organic insulating film PLN2 (step S220).

Then, the fourth inorganic insulating film ILD4 is formed on the plurality of first electrodes E1 (step S230). The fourth inorganic insulating film ILD4 may be a single layer containing silicon oxide (SiOₓ), silicon nitride (SiNₓ), or silicon oxynitride (SiOₓN_{y}), or may be a multilayer in which silicon oxide and silicon nitride are alternately layered. The fourth inorganic insulating film ILD4 may be formed by forming one or more of silicon nitride, silicon oxide, and silicon oxynitride to have a thickness of 100 nm or more and 400 nm or less in total.

The liquid repellent layer WR1 is formed on the fourth inorganic insulating film ILD4 (step S240). The liquid repellent layer WR1 may be formed by applying a water-repellent surface treatment agent such as a fluorine-based coating agent onto the fourth inorganic insulating film ILD4 and drying the water-repellent surface treatment agent. An application method may be any method such as a dip coating method, a slit coating method, or a printing method. The thickness of the liquid repellent layer WR1 may be 30 nm or more and 100 nm or less. As a result, the first substrate CB1 is formed (step S100).

The support body SB2 of the second substrate CB2 is prepared (step S310), the second electrode E2 is formed on the support body SB2 (step S320), the inorganic insulating film ILD10 is formed on the second electrode E2 (step S330), and the liquid repellent layer WR2 is formed on the inorganic insulating film ILD10 (step S340). As a result, the second substrate CB2 is formed (step S300).

The first substrate CB1 includes a mounting terminal, and the fourth inorganic insulating film ILD4 and the liquid repellent layer WR1 of the first substrate CB1 are patterned so that the mounting terminal is exposed. The patterning may be performed by photolithography and dry etching, or by a lift-off method. The second substrate CB2 also includes a mounting terminal, and the inorganic insulating film ILD10 and the liquid repellent layer WR2 of the second substrate CB2 are also patterned so that the mounting terminal is exposed.

After both the first substrate CB1 and the second substrate CB2 are completed, the second substrate CB2 is fixed to the first substrate CB1 so that the gap GP is maintained between the first substrate CB1 and the second substrate CB2 (step S400). The first and second electrodes E1 and E2 are located between the support bodies SB1 and SB2 of the first and second substrates CB1 and CB2, and the gap GP is located between the first and second electrodes E1 and E2. In order to maintain the gap GP, a spacer may be provided between the first substrate CB1 and the second substrate CB2.

### Example

The manufacture of the first substrate CB1 in one example of the first embodiment will be described below with reference to FIGS. 1 and 9.

A glass substrate was prepared as the support body SB1 of the first substrate CB1 (step S110), and a silicon oxide film with a 100 nm thickness and a silicon nitride film with a 100 nm thickness were formed in this order on the glass substrate by a chemical vapor deposition (CVD) apparatus, thereby forming a base coat film. The base coat film corresponds to the inorganic insulating film ILD9 in FIG. 1. LTPS with a 40 nm thickness was formed on the base coat film, and the LTPS was subjected to a dehydrogenation annealing treatment and a laser annealing treatment, and the LTPS was patterned, thereby forming a semiconductor layer SC. A silicon oxide film with a 100 nm thickness was formed on the semiconductor layer SC by a CVD apparatus, thereby forming a gate insulating film. The gate insulating film corresponds to the inorganic insulating film ILD8 in FIG. 1. A molybdenum tungsten (MoW) alloy film with a 300 nm thickness was formed on the gate insulating film by a sputtering apparatus, and the MoW alloy film was patterned, thereby forming a gate electrode. The gate electrode corresponds to the wiring line W3 in FIG. 1.

Subsequently, the semiconductor layer SC was subjected to a low-concentration doping treatment and a high-concentration doping treatment through the gate insulating film and the gate electrode. After the doping, a silicon oxide film with a 700 nm thickness and a silicon nitride film with a 200 nm thickness were formed on the gate electrode by a CVD apparatus, thereby forming a first interlayer insulating film. The first interlayer insulating film corresponds to the inorganic insulating film ILD7 in FIG. 1. A connection contact hole was formed in the first interlayer insulating film, a titanium film with 30 nm thickness, an aluminum film with 300 nm thickness, and a titanium film with 20 nm thickness were formed in this order on the first interlayer insulating film by a sputtering apparatus, and a titanium/aluminum/titanium layered body was patterned, thereby forming a source electrode. The source electrode corresponds to the wiring line W2 in FIG. 1.

Subsequently, a silicon nitride film with a 300 nm thickness was formed on the source electrode by a CVD apparatus, thereby forming a second interlayer insulating film. The second interlayer insulating film corresponds to the third inorganic insulating film ILD3 in FIG. 1. A connection contact hole was formed in the second interlayer insulating film, a titanium film with 100 nm thickness, an aluminum film with 600 nm thickness, and a titanium film with 20 nm thickness were formed in this order on the second interlayer insulating film by a sputtering apparatus, and a Ti/Al/Ti layered body was patterned, thereby forming an electrode. The electrode corresponds to the wiring line W1 in FIG. 1.

Subsequently, a silicon oxide film with a 400 nm thickness and a silicon nitride film with a 150 nm thickness were formed on the electrode by a CVD apparatus, thereby forming a third interlayer insulating film. The third interlayer insulating film corresponds to the inorganic insulating film ILD6 in FIG. 1. A liquid containing a photoresist was applied onto the third interlayer insulating film and solidified the liquid, thereby forming a first flattened layer. The first flattened layer corresponds to the first organic insulating film PLN1 in FIG. 1. The first flattened layer was patterned by photolithography of 2 μm, thereby forming the contact hole CH extending through the first flattened layer. The above corresponds to steps S110 to S140 in FIG. 9.

Subsequently, a silicon oxide film with a 100 nm thickness was formed on the first organic insulating film PLN1 by a CVD apparatus, thereby forming the first inorganic insulating film ILD1 (step S150). Then, the third interlayer insulating film and the first inorganic insulating film ILD1 were etched at the same time, thereby forming a connection contact hole that passes through the contact hole CH1 and extends through the third interlayer insulating film and the first inorganic insulating film ILD1. Then, a titanium film with 100 nm thickness was formed on the first inorganic insulating film ILD1 by a sputtering apparatus, and the titanium film was patterned, thereby forming the metal layer ML and the first through-conductor TH1 (step side S160).

Subsequently, a silicon nitride film with a 100 nm thickness was formed on the metal layer ML by a CVD apparatus, thereby forming the fifth inorganic insulating film ILD5 (step S170). Then, a liquid containing a photoresist was applied onto the fifth inorganic insulating film ILD5 and solidified the liquid, thereby forming a second flattened layer (step S180). The second flattened layer corresponds to the second organic insulating film PLN2 in FIG. 1. The second flattened layer was patterned by photolithography of 2 μm, thereby forming the contact hole CH2 extending through the second flattened layer (step S190).

Subsequently, a silicon nitride film with a 200 nm thickness was formed on the second organic insulating film PLN2 by a CVD apparatus, thereby forming the second inorganic insulating film ILD2 (step S210). Then, the fifth inorganic insulating film ILD5 and the second inorganic insulating film ILD2 were etched at the same time, thereby forming a connection contact hole that passes through the contact hole CH2 and extends through the fifth inorganic insulating film ILD5 and the second inorganic insulating film ILD2. Then, a titanium film with 300 nm thickness was formed on the second inorganic insulating film ILD2 by a sputtering apparatus, and the titanium film was patterned, thereby forming the plurality of first electrodes E1 and the second through-conductor TH2 (step side S220).

The fourth inorganic insulating film ILD4 was formed on the plurality of first electrodes E1 (step S230). Then, the fourth inorganic insulating film ILD4 was patterned using photolithography and dry etching so as to remove the fourth inorganic insulating film ILD4 on the mounting terminal. A surface treatment agent for forming a fluorine-based water-repellent film was applied onto the fourth inorganic insulating film ILD4 and dried, thereby forming the liquid repellent layer WR1. Then, the liquid repellent layer WR1 was patterned using photolithography and dry etching so as to remove the liquid repellent layer WR1 on the mounting terminal.

### Second Embodiment

Another embodiment of the disclosure will be described below. Further, members having the same functions as those of the members described in the above-described embodiment will be denoted by the same reference numerals and signs, and a description thereof will not be repeated for convenience of description.

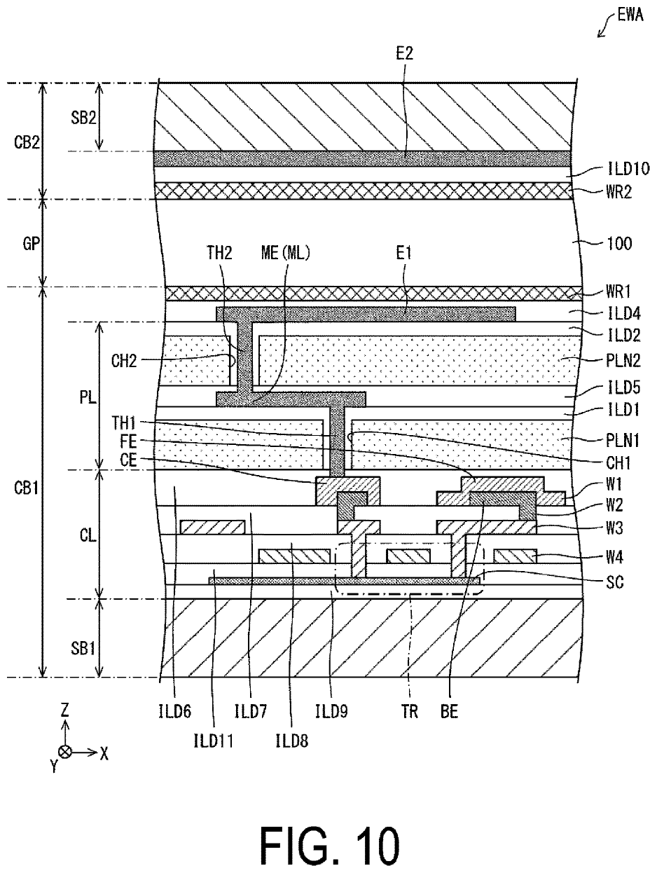

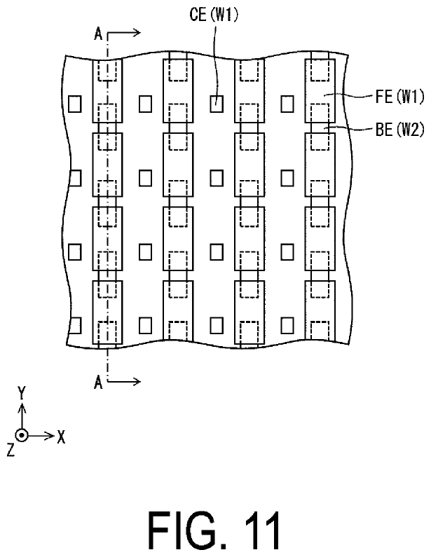

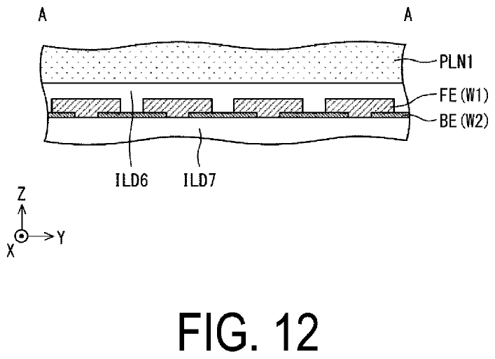

FIG. 10 is a partial cross-sectional view illustrating a configuration example of the electrowetting device EWA according to an embodiment of the disclosure. FIG. 11 is a partial plan view illustrating the configuration example of the first wiring line W1 in the electrowetting device EWA illustrated in FIG. 10, together with a part of the second wiring line W2. FIG. 12 is a partial cross-sectional view illustrating a cross section taken along a line AA in FIG. 11. For the sake of simplicity of the drawings, the second wiring line W2 in FIGS. 11 and 12 illustrates only relay electrodes BE, each connected to two or more supply electrodes FE.

As illustrated in FIGS. 10 to 12, when the first wiring line W1 includes (i) the plurality of connection electrodes CE each connected to both corresponding one of the plurality of first electrodes E1 and corresponding one of the plurality of circuit elements TR, and (ii) a plurality of the supply electrodes FE each not connected to any of the plurality of first electrodes E1 and connected to corresponding one or more of the plurality of circuit elements TR, and the second wiring line W2 includes the plurality of relay electrodes BE, each connected to the corresponding two or more of the plurality of supply electrodes FE, it is advantageous that the second wiring line W2 is made of a metal that is not eroded by the liquid 100. According to this configuration, even when the liquid 100 reaches and erodes one of the plurality of supply electrodes FE, the relay electrode BE is not eroded by the liquid 100, and it is difficult for the liquid 100 to reach the other supply electrodes FE via the relay electrode BE. Thus, the number of circuit elements TR damaged by one crack can be further reduced.

The first substrate CB1 need not include the third inorganic insulating film ILD3 located between the first wiring line W1 and the second wiring line W2. The first wiring line W1 may be located between the second wiring line W2 and the first organic insulating film PLN1, and the first wiring line W1 may be in direct contact with the second wiring line W2.

The circuit layer CL of the first substrate CB1 may include one or more wiring lines, such as the third wiring line W3 and the fourth wiring line W4, which are located between the support body SB1 and the first wiring line W1 and containing a metal that is eroded by the liquid 100. The circuit layer CL may include a plurality of inorganic insulating films such as the inorganic insulating film ILD6 located between the first wiring line W1 and the first organic insulating film PLN1, the inorganic insulating film ILD7 located between the third wiring line W3 and the second wiring line W2, the inorganic insulating film ILD8 located between the fourth wiring line W4 and the third wiring line W3, the inorganic insulating film ILD11 located between the semiconductor layer SC and the fourth wiring line W4, the inorganic insulating film ILD9 located between the support body SB1 and the third wiring line W3, and the like.

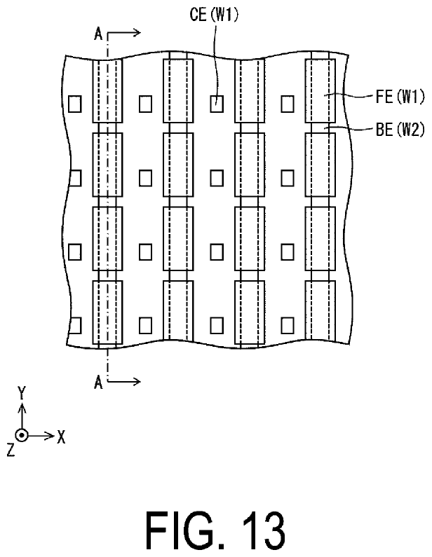

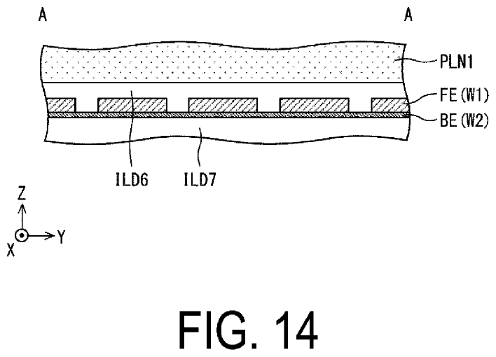

FIG. 13 is a partial plan view illustrating another configuration example of the first wiring line W1 in the electrowetting device EWA illustrated in FIG. 10, together with a part of the second wiring line W2. FIG. 14 is a partial cross-sectional view illustrating a cross section taken along a line AA in FIG. 13. For the sake of simplicity of the drawings, the second wiring line W2 in FIGS. 13 and 14 illustrate only relay electrodes BE, each connected to two or more supply electrodes FE. As illustrated in FIGS. 13 and 14, the relay electrode BE may be connected to three or more supply electrodes FE. According to the configuration example in FIGS. 13 and 14, the electrical resistance of the wiring line in which the supply electrode FE and the relay electrode BE are combined is smaller than that in the configuration example in FIGS. 11 and 12.

### Example

The manufacture of the first substrate CB1 in one example of the second embodiment will be described below with reference to FIG. 10.

As in the example of the first embodiment described above, the support body SB1 was prepared, and the base coat film through the second interlayer insulating film were formed and appropriately patterned. The base coat film, the LTPS, and the gate insulating film in the example of the second embodiment correspond to the inorganic insulating film ILD9, the semiconductor layer SC, and the inorganic insulating film ILD11, respectively, in FIG. 10. The gate electrodes, the first interlayer insulating film, the source electrode, and the second interlayer insulating film in the example of the second embodiment correspond to the fourth wiring line W4, the inorganic insulating film ILD8, the third wiring line W3, and the inorganic insulating film ILD7, respectively, in FIG. 10.

Subsequently, a titanium film with 100 nm thickness was formed on the second interlayer insulating film by a sputtering apparatus, and the titanium film was patterned, thereby forming the second wiring line W2. A titanium film with 100 nm thickness, an aluminum film with 600 nm thickness, and a titanium film with 20 nm thickness were formed in this order on the second interlayer insulating film and the second wiring line W2 by a sputtering apparatus, and the Ti/Al/Ti layered body was patterned, thereby forming the first wiring line W1.

Subsequently, as in the example of the first embodiment described above, the third interlayer insulating film through the liquid repellent layer WR1 were formed and appropriately patterned. The third interlayer insulating film, the first flattened layer, and the second flattened layer in the example of the second embodiment correspond to the inorganic insulating film ILD6, the first organic insulating film PLN1, and the second organic insulating film PLN2, respectively, in FIG. 10.

### Third Embodiment

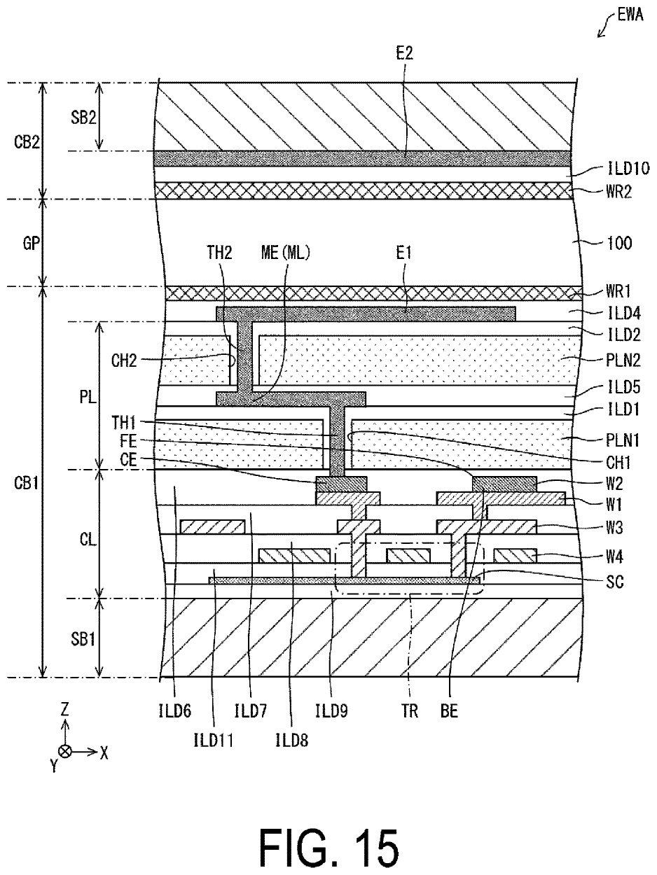

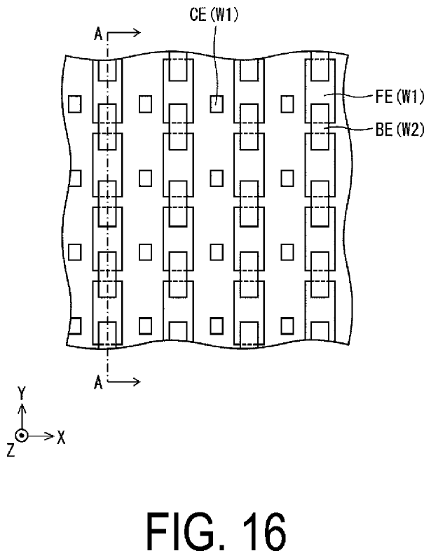

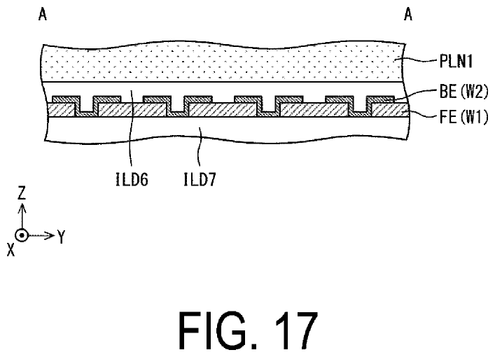

FIG. 15 is a partial cross-sectional view illustrating a configuration example of the electrowetting device EWA according to an embodiment of the disclosure. FIG. 16 is a partial plan view illustrating the configuration example of the first wiring line W1 in the electrowetting device EWA illustrated in FIG. 15, together with a part of the second wiring line W2. FIG. 17 is a partial cross-sectional view illustrating a cross section taken along a line AA in FIG. 16. For the sake of simplicity of the drawings, the second wiring line W2 in FIGS. 16 and 17 illustrate only relay electrodes BE, each connected to two or more supply electrodes FE. As illustrated in FIGS. 15 to 17, the second wiring line W2 may be located between the first wiring line W1 and the first organic insulating film PLN1, and the second wiring line W2 may be in direct contact with the first wiring line W1.

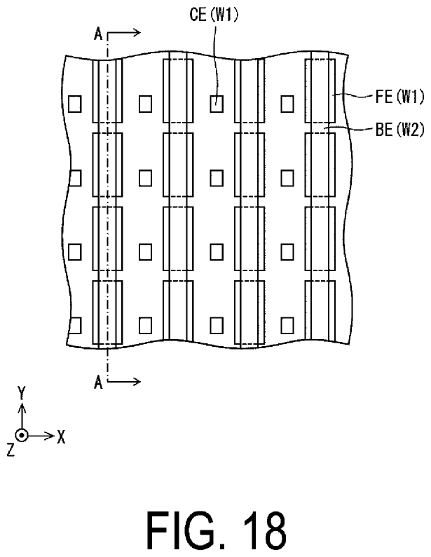

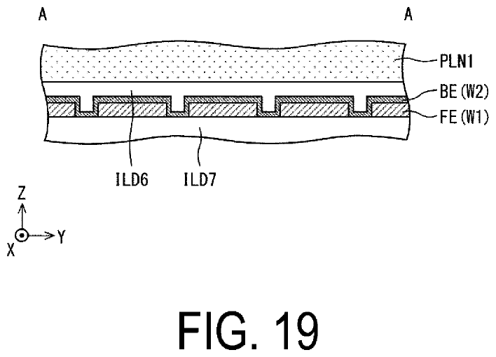

FIG. 18 is a partial plan view illustrating another configuration example of the first wiring line W1 in the electrowetting device EWA illustrated in FIG. 15, together with a part of the second wiring line W2. FIG. 19 is a partial cross-sectional view illustrating a cross section taken along a line AA in FIG. 18. For the sake of simplicity of the drawings, the second wiring line W2 in FIGS. 18 and 19 illustrate only relay electrodes BE, each connected to two or more supply electrodes FE. As illustrated in FIGS. 18 and 19, the relay electrode BE may be connected to three or more supply electrodes FE. According to the configuration example in FIGS. 18 and 19, the electrical resistance of the wiring line in which the supply electrode FE and the relay electrode BE are combined is smaller than that in the configuration example in FIGS. 16 and 17.

### Example

The manufacture of the first substrate CB1 in one example of the third embodiment will be described below with reference to FIG. 15. As in the examples of the first and second embodiments described above, the support body SB1 was prepared, and the base coat film through the second interlayer insulating film were formed and appropriately patterned. The base coat film, the LTPS, and the gate insulating film in the example of the third embodiment correspond to the inorganic insulating film ILD9, the semiconductor layer SC, and the inorganic insulating film ILD11, respectively, in FIG. 15. The gate electrodes, the first interlayer insulating film, the source electrode, and the second interlayer insulating film in the example of the third embodiment correspond to the fourth wiring line W4, the inorganic insulating film ILD8, the third wiring line W3, and the inorganic insulating film ILD7, respectively, in FIG. 15.

Subsequently, a titanium film with 100 nm thickness, an aluminum film with 600 nm thickness, and a titanium film with 20 nm thickness were formed in this order on the second interlayer insulating film by a sputtering apparatus, and the Ti/Al/Ti layered body was patterned, thereby forming the first wiring line W1. Then, a titanium film with 100 nm thickness was formed on the second interlayer insulating film and the first wiring line W1 by a sputtering apparatus, and the titanium film was patterned, thereby forming the second wiring line W2.

Subsequently, as in the examples of the first and second embodiments described above, the third interlayer insulating film through the liquid repellent layer WR1 were formed and appropriately patterned. The third interlayer insulating film, the first flattened layer, and the second flattened layer in the example of the third embodiment correspond to the inorganic insulating film ILD6, the first organic insulating film PLN1, and the second organic insulating film PLN2, respectively, in FIG. 15.

### Fourth Embodiment

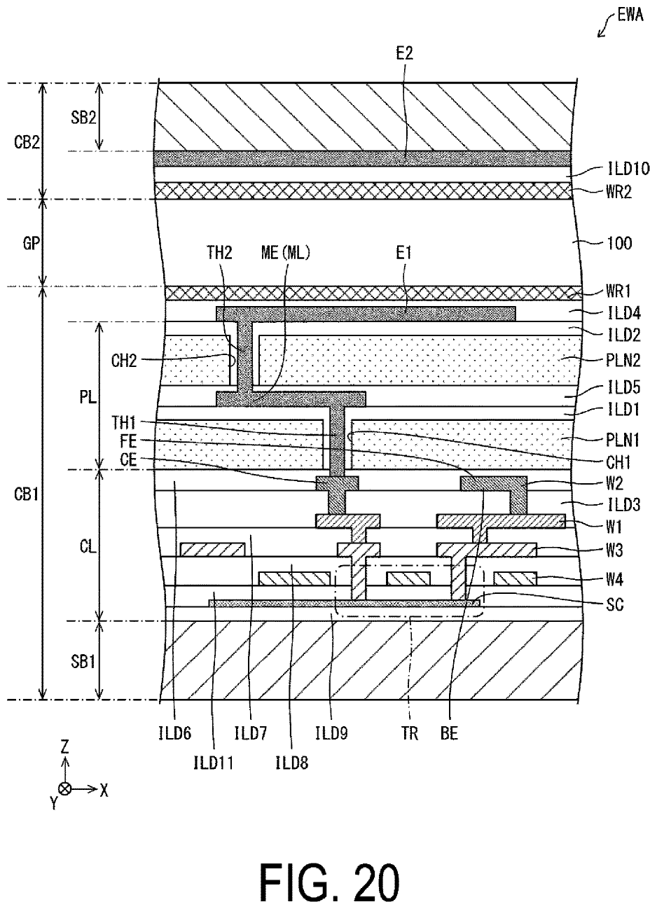

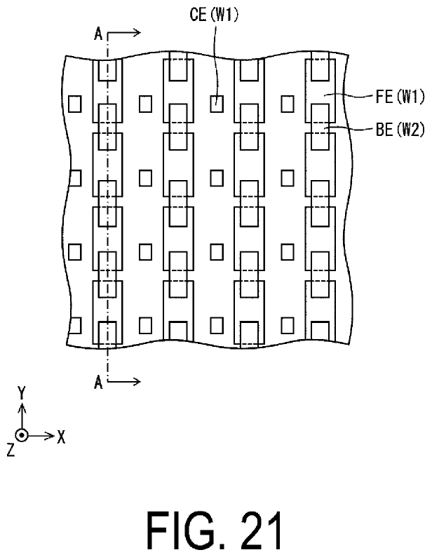

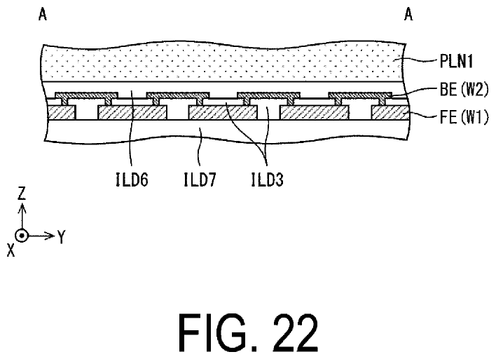

FIG. 20 is a partial cross-sectional view illustrating a configuration example of the electrowetting device EWA according to an embodiment of the disclosure. FIG. 21 is a partial plan view illustrating the configuration example of the first wiring line W1 in the electrowetting device EWA illustrated in FIG. 20, together with a part of the second wiring line W2. FIG. 22 is a partial cross-sectional view illustrating a cross section taken along a line AA in FIG. 21. For the sake of simplicity of the drawings, the second wiring line W2 in FIGS. 21 and 22 illustrates only relay electrodes BE, each connected to two or more supply electrodes FE. As illustrated in FIGS. 20 to 22, the second wiring line W2 may be located between the first wiring line W1 and the first organic insulating film PLN1, and the first substrate CB1 may include the third inorganic insulating film ILD3 located between the first wiring line W1 and the second wiring line W2.

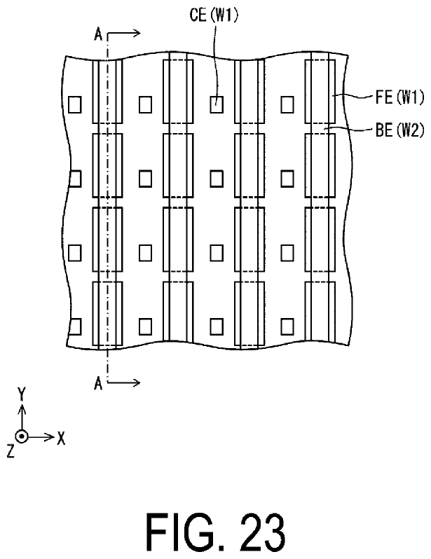

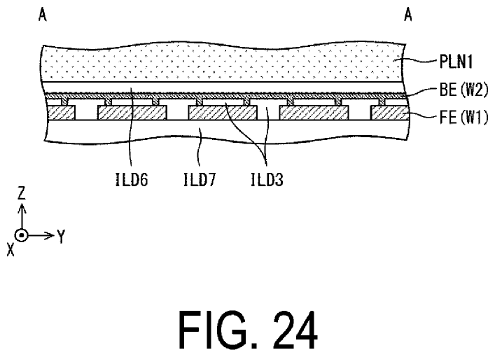

FIG. 23 is a partial plan view illustrating another configuration example of the first wiring line W1 in the electrowetting device EWA illustrated in FIG. 20, together with a part of the second wiring line W2. FIG. 24 is a partial cross-sectional view illustrating a cross section taken along a line AA in FIG. 23. For the sake of simplicity of the drawings, the second wiring line W2 in FIGS. 23 and 24 illustrates only relay electrodes BE, each connected to two or more supply electrodes FE. As illustrated in FIGS. 23 and 24, the relay electrode BE may be connected to three or more supply electrodes FE. According to the configuration example in FIGS. 23 and 24, the electrical resistance of the wiring line in which the supply electrode FE and the relay electrode BE are combined is smaller than that in the configuration example in FIGS. 21 and 22.

### Example

The manufacture of the first substrate CB1 in one example of the fourth embodiment will be described below with reference to FIG. 20. As in the examples of the first to third embodiments described above, the support body SB1 was prepared, and the base coat film through the second interlayer insulating film were formed and appropriately patterned. The base coat film, the LTPS, and the gate insulating film in the example of the fourth embodiment correspond to the inorganic insulating film ILD9, the semiconductor layer SC, and the inorganic insulating film ILD11, respectively, in FIG. 20. The gate electrodes, the first interlayer insulating film, the source electrode, and the second interlayer insulating film in the example of the fourth embodiment correspond to the fourth wiring line W4, the inorganic insulating film ILD8, the third wiring line W3, and the inorganic insulating film ILD7, respectively, in FIG. 20.

Subsequently, a titanium film with 100 nm thickness, an aluminum film with 600 nm thickness, and a titanium film with 20 nm thickness were formed in this order on the second interlayer insulating film by a sputtering apparatus, and the Ti/Al/Ti layered body was patterned, thereby forming the first wiring line W1. Then, a silicon nitride film with a 100 nm thickness was formed on the first wiring line W1 by a CVD apparatus, thereby forming a fourth interlayer insulating film. The fourth interlayer insulating film corresponds to the third inorganic insulating film ILD3 in FIG. 20. Then, a connection contact hole was formed in the fourth interlayer insulating film, a titanium film with 100 nm thickness was formed on the fourth interlayer insulating film by a sputtering apparatus, and the titanium film was patterned, thereby forming the second wiring line W2.

Subsequently, as in the examples of the first to third embodiments described above, the third interlayer insulating film through the liquid repellent layer WR1 were formed and appropriately patterned. The third interlayer insulating film, the first flattened layer, and the second flattened layer in the example of the third embodiment correspond to the inorganic insulating film ILD6, the first organic insulating film PLN1, and the second organic insulating film PLN2, respectively, in FIG. 15.

### Fifth Embodiment

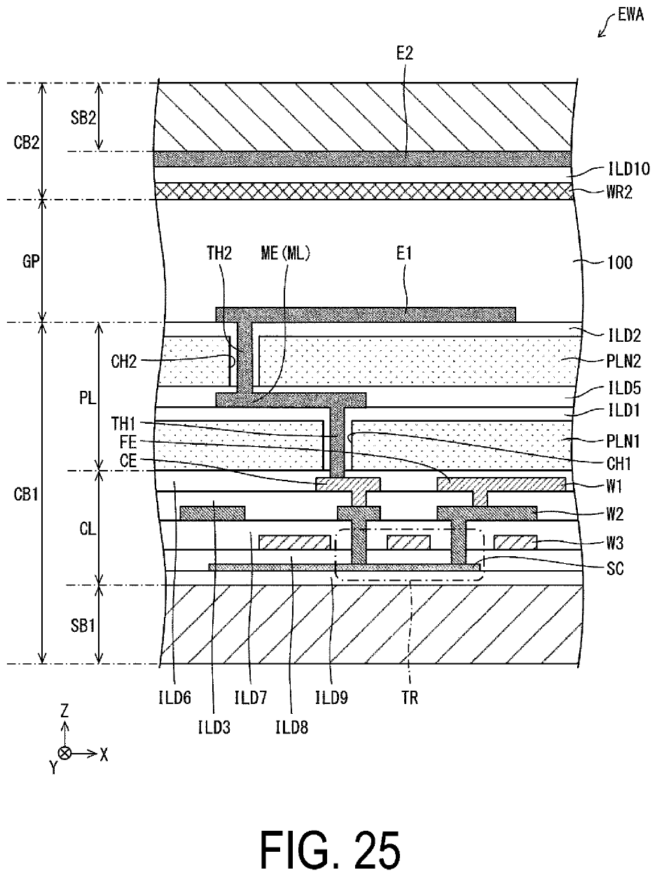

FIG. 25 is a partial cross-sectional view illustrating a configuration example of the electrowetting device EWA according to an embodiment of the disclosure. As illustrated in FIG. 25, the electrowetting device EWA may be configured such that at least one of the plurality of first electrodes E1 is in direct contact with the liquid 100. In other words, in the first substrate CB1 included in the electrowetting device EWA according to the disclosure, one or more of the plurality of first electrodes E1 may be exposed to the interior of the gap GP.

Note that the configuration according to the fifth embodiment can be combined with the configurations according to the second to fourth embodiments described above. Configurations in which the second inorganic insulating film ILD2 and the liquid repellent layer WR1 are removed from the first substrate CB1 according to the second to fourth embodiments are also included in the scope of the disclosure.

### Supplement

A device according to a first aspect of the disclosure is a device for applying a voltage to a liquid, and the device is configured to include a first substrate including a support body, a plurality of first electrodes, a first wiring line located between the support body and the plurality of first electrodes, a first organic insulating film located between the first wiring line and the plurality of first electrodes, a second organic insulating film located between the first organic insulating film and the plurality of first electrodes, and a metal layer located between the first organic insulating film and the second organic insulating film and formed of a metal that is not eroded by the liquid, a second substrate including a second electrode facing the plurality of first electrodes, wherein a gap into which the liquid is injected or is injectable is maintained between the first substrate and the second substrate.

According to the above configuration, the electrowetting device according to the disclosure includes, between the first wiring line and the plurality of first electrodes, a protection layer including the first organic insulating film, the second organic insulating film, and the metal layer located between the first organic insulating film and the second organic insulating film and formed of a metal that is not eroded by the liquid 100. Thus, the protection layer according to the disclosure is less likely to be penetrated by a crack in the thickness direction. In addition, even when the total thickness of the protection layer is large, it is easy to electrically connect the first electrode to the first wiring line.

The device according to a second aspect of the disclosure may be configured such that, in the first aspect, the first substrate further includes a first inorganic insulating film located between the first wiring line and the plurality of first electrodes.

According to the above configuration, entering of the liquid to the first wiring line can be further reduced.

The device according to a third aspect of the disclosure may be configured such that, in the first or second aspect, the first inorganic insulating film is located between the first organic insulating film and the second organic insulating film.

According to the above configuration, entering of the liquid to the first wiring line can be further reduced.

The device according to a fourth aspect of the disclosure, may be configured such that, in the third aspect, the first substrate further includes a second inorganic insulating film located between the second organic insulating film and the plurality of first electrodes.

According to the above configuration, entering of the liquid to the first wiring line can be further reduced.

The device according to a fifth aspect of the disclosure, may be configured such that, in any one of the first to fourth aspects, the first substrate further includes a first through-conductor penetrating the first organic insulating film and a second through-conductor penetrating the second organic insulating film, one of the plurality of first electrodes is connected to the metal layer through the second through-conductor, the metal layer is connected to the first wiring line through the first through-conductor, and the second through-conductor is separated from the first through-conductor in a plan view.

According to the above configuration, entering of the liquid to the first wiring line can be further reduced.

The device according to a sixth aspect of the disclosure may be configured such that, in any one of the first to fifth aspects, the first wiring line among wiring lines including a metal that is eroded by the liquid is a wiring line closest to the plurality of first electrodes.

According to the above configuration, since the liquid is less likely to reach the first wiring line, the liquid is less likely to reach all of the wiring lines containing the metal that is eroded by the liquid.

The device according to a seventh aspect of the disclosure may be configured such that, in any one of the first to sixth aspects, the first substrate further includes a plurality of circuit elements located between the support body and the first wiring line and corresponding to the plurality of first electrodes, respectively, the first wiring line includes a plurality of connection electrodes each connected to both corresponding one of the plurality of first electrodes and corresponding one of the plurality of circuit elements, and one supply electrode not connected to the plurality of first electrodes and connected to the plurality of circuit elements, and an area of the supply electrode in a plan view is 80% or less of an area of the first substrate in a plan view.

According to the above configuration, the area of the supply electrode FE in a plan view is small. Thus, even when a crack penetrates the protection layer in the thickness direction, the probability that the supply electrode is present ahead of the crack is small.

The device according to an eighth aspect of the disclosure may be configured such that, in any one of the first to sixth aspects, the first substrate further includes a plurality of circuit elements located between the support body and the first wiring line and corresponding to the plurality of first electrodes, respectively, the first wiring line includes a plurality of connection electrodes each connected to both corresponding one of the plurality of first electrodes and corresponding one of the plurality of circuit elements, and a plurality of supply electrodes not connected to the plurality of first electrodes and connected to corresponding one or more of the plurality of circuit elements, and the plurality of supply electrodes are spaced apart from each other and the plurality of connection electrodes in a plan view.

According to the above configuration, the supply electrodes are separated from each other and are also separated from the connection electrode. Thus, even when the liquid reaches one of the plurality of supply electrodes, the liquid is less likely to reach the other supply electrodes and the connection electrodes. Thus, the number of circuit elements damaged by one crack can be further reduced.

The device according to a ninth aspect of the disclosure may be configured such that, in the eighth aspect, the first substrate further includes a second wiring line located between the plurality of circuit elements and the first organic insulating film, and the second wiring line includes a plurality of relay electrodes each connected to corresponding two or more of the plurality of supply electrodes.

According to the above configuration, the supply electrode can be divided in both a row direction and a column direction by the relay electrodes. Thus, the number of circuit elements damaged by one crack can be further reduced.

The device according to a tenth aspect of the disclosure, may be configured such that, in the ninth aspect, the second wiring line is made of the metal that is not eroded by the liquid.

According to the above configuration, even when the liquid reaches and erodes one of the plurality of supply electrodes, the relay electrode is not eroded by the liquid, and it is difficult for the liquid to reach the other supply electrodes via the relay electrode. Thus, the number of circuit elements damaged by one crack can be further reduced.

The device according to an eleventh aspect of the disclosure may be configured such that, in the ninth or tenth aspect, the plurality of circuit elements include a first circuit element, a second circuit element adjacent to the first circuit element on one side in a row direction, a third circuit element adjacent to the first circuit element on one side in a column direction, and a fourth circuit element adjacent to the first circuit element on the other side in the column direction, the plurality of supply electrodes include a first supply electrode corresponding to the first circuit element, a second supply electrode corresponding to the second circuit element, a third supply electrode corresponding to the third circuit element, and a fourth supply electrode corresponding to the fourth circuit element, and the plurality of relay electrodes include a first relay electrode connected to the first supply electrode and the second supply electrode, a second relay electrode connected to the first supply electrode and the third supply electrode, and a third relay electrode connected to the first supply electrode and the fourth supply electrode.

According to the above configuration, the number of circuit elements damaged by one crack can be further reduced. In addition, the number of line defects in which the plurality of circuit elements arranged in the column direction are damaged can be reduced.

The device according to a twelfth aspect of the disclosure may be configured such that, in any one of the ninth to eleventh aspects, the first wiring line is located between the second wiring line and the first organic insulating film, and the first wiring line is in direct contact with the second wiring line.

The device according to a thirteenth aspect of the disclosure may be configured such that, in any one of the ninth to eleventh aspects, the second wiring line is located between the first wiring line and the first organic insulating film, and the second wiring line is in direct contact with the first wiring line.

The device according to a fourteenth aspect of the disclosure may be configured such that, in any one of the ninth to eleventh aspects, the second wiring line is located between the first wiring line and the first organic insulating film, and the first substrate further includes a third inorganic insulating film located between the first wiring line and the second wiring line.

The device according to a fifteenth aspect of the disclosure may be configured such that, in any one of the first to fourteenth aspects, the metal that is not eroded by the liquid is a noble metal or a metal that reacts with the liquid to form a passive layer.

The device according to a sixteenth aspect of the disclosure may be configured such that, in any one of the first to fifteenth aspects, the metal that is not eroded by the liquid is a metal selected from the group consisting of titanium, niobium, tungsten, chromium, and nickel, or an alloy of two or more metals selected from the group.

The device according to a seventeenth aspect of the disclosure may be configured such that, in any one of the first to sixteenth aspects, the first substrate includes a liquid repellent layer located on the opposite side of the support body with respect to the plurality of first electrodes and configured to repel the liquid, and a fourth inorganic insulating film located between the plurality of first electrodes and the liquid repellent layer.

According to the above configuration, the liquid repellent layer and the fourth inorganic insulating film reduce the contact of the liquid with the first electrode and the first wiring line.

The device according to an eighteenth aspect of the disclosure may be configured such that, in any one of the first to sixteenth aspects, one or more of the plurality of first electrodes are exposed to the interior of the gap.

According to the above configuration, one or more first electrodes can be in direct contact with the liquid 100.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A device configured to apply a voltage to a liquid, the device comprising:
a first substrate including
a support body,
a plurality of first electrodes,
a first wiring line located between the support body and the plurality of first electrodes,
a first organic insulating film located between the first wiring line and the plurality of first electrodes,
a second organic insulating film located between the first organic insulating film and the plurality of first electrodes, and
a metal layer located between the first organic insulating film and the second organic insulating film and formed of a metal that is not eroded by the liquid; and
a second substrate including a second electrode facing the plurality of first electrodes,
wherein a gap into which the liquid is injected or is injectable is maintained between the first substrate and the second substrate.

2. The device according to claim 1,
wherein the first substrate further includes a first inorganic insulating film located between the first wiring line and the plurality of first electrodes.

3. The device according to claim 2,
wherein the first inorganic insulating film is located between the first organic insulating film and the second organic insulating film.

4. The device according to claim 3,
wherein the first substrate further includes a second inorganic insulating film located between the second organic insulating film and the plurality of first electrodes.

5. The device according to claim 1,
wherein the first substrate further includes a first through-conductor penetrating the first organic insulating film and a second through-conductor penetrating the second organic insulating film,
one of the plurality of first electrodes is connected to the metal layer through the second through-conductor,
the metal layer is connected to the first wiring line through the first through-conductor, and
the second through-conductor is separated from the first through-conductor in a plan view.

6. The device according to claim 1,
wherein the first wiring line among wiring lines including a metal that is eroded by the liquid is a wiring line closest to the plurality of first electrodes.

7. The device according to claim 1,
wherein the first substrate further includes a plurality of circuit elements located between the support body and the first wiring line and corresponding to the plurality of first electrodes, respectively,
the first wiring line includes
a plurality of connection electrodes each connected to both corresponding one of the plurality of first electrodes and corresponding one of the plurality of circuit elements, and
one supply electrode not connected to the plurality of first electrodes and connected to the plurality of circuit elements, and
an area of the supply electrode in a plan view is 80% or less of an area of the first substrate in a plan view.

8. The device according to claim 1,
wherein the first substrate further includes a plurality of circuit elements located between the support body and the first wiring line and corresponding to the plurality of first electrodes, respectively,
the first wiring line includes
a plurality of connection electrodes each connected to both corresponding one of the plurality of first electrodes and corresponding one of the plurality of circuit elements, and
a plurality of supply electrodes not connected to the plurality of first electrodes and connected to corresponding one or more of the plurality of circuit elements, and
the plurality of supply electrodes are spaced apart from each other and the plurality of connection electrodes in a plan view.

9. The device according to claim 8,
wherein the first substrate further includes a second wiring line located between the plurality of circuit elements and the first organic insulating film, and
the second wiring line includes a plurality of relay electrodes each connected to corresponding two or more of the plurality of supply electrodes.

10. The device according to claim 9,
wherein the second wiring line is made of the metal that is not eroded by the liquid.

11. The device according to claim 9,
wherein the plurality of circuit elements include
a first circuit element,
a second circuit element adjacent to the first circuit element on one side in a row direction,
a third circuit element adjacent to the first circuit element on one side in a column direction, and
a fourth circuit element adjacent to the first circuit element on the other side in the column direction,
the plurality of supply electrodes include
a first supply electrode corresponding to the first circuit element,
a second supply electrode corresponding to the second circuit element,
a third supply electrode corresponding to the third circuit element, and
a fourth supply electrode corresponding to the fourth circuit element, and
the plurality of relay electrodes include
a first relay electrode connected to the first supply electrode and the second supply electrode,
a second relay electrode connected to the first supply electrode and the third supply electrode, and
a third relay electrode connected to the first supply electrode and the fourth supply electrode.

12. The device of claim 9,
wherein the first wiring line is located between the second wiring line and the first organic insulating film, and
the first wiring line is in direct contact with the second wiring line.

13. The device of claim 9,
wherein the second wiring line is located between the first wiring line and the first organic insulating film, and
the second wiring line is in direct contact with the first wiring line.

14. The device according to claim 9,
wherein the second wiring line is located between the first wiring line and the first organic insulating film, and
the first substrate further includes a third inorganic insulating film located between the first wiring line and the second wiring line.

15. The device according to claim 1,
wherein the metal that is not eroded by the liquid is a noble metal or a metal that reacts with the liquid to form a passive layer.

16. The device according to claim 1,
wherein the metal that is not eroded by the liquid is a metal selected from the group consisting of titanium, niobium, tungsten, chromium, and nickel, or an alloy of two or more metals selected from the group.

17. The device according to claim 1,
wherein the first substrate includes
a liquid repellent layer located on the opposite side of the support body with respect to the plurality of first electrodes and configured to repel the liquid, and
a fourth inorganic insulating film located between the plurality of first electrodes and the liquid repellent layer.

18. The device according to claim 1,
wherein one or more of the plurality of first electrodes are exposed to the interior of the gap.
